(19) United States
(12) Patent Application Publication
(10) Pub. No.: US 2007/0219991 A1
(43) Pub. Date: Sep. 20, 2007

(54) System and method for delivering targeted data to a subscriber base via a computer network

(76) Inventor: David Guthrie, Smyrna, GA (US)

Correspondence Address: WILMER CUTLER PICKERING HALE AND DORR LLP, 60 STATE STREET, BOSTON, MA, 02109, US

(21) Appl. No.: 11/586,402

(22) Filed: Oct. 24, 2006

Related U.S. Application Data
(63) Continuation of application No. 10/643,840, filed on Aug. 19, 2003, now abandoned.
Application No. 10/643,840 is a continuation of application No. 09/510,559, filed on Feb. 22, 2000, now abandoned.
(60) Provisional application No. 60/121,099, filed on Feb. 22, 1999.

(51) Int. Cl. G06F 17/30

(52) U.S. Cl. 707/6

(57) ABSTRACT

A system and method for providing a user with a customized data based on the user profile. A system comprises a server that collects electronic data based on the user profile. The server then generates a checksum of the collected data and sends it to the user. Based on the checksum, the user notifies the server of the data that has been previously sent. In response, the server sends to the user data that has not been previously sent to the user.

### CROSS-REFERENCE TO RELATED APPLICATION

This application is a continuation of and incorporates by reference herein the U.S. patent application Ser. No. 10/643,840 filed Aug. 19, 2006, which is a continuation of the U.S. patent application Ser. No. 09/510,559 filed Feb. 22, 2000, which claims the benefit of the filing date of the U.S. provisional application No. 60/121,099 filed Feb. 22, 1999.

### FIELD OF THE INVENTION

This invention relates to the delivery of data over a computer network, and more particularly, to the delivery of data that conforms to information about subscribers within the subscriber base.

### BACKGROUND OF THE INVENTION

Computer networks are known and used to deliver files and other aggregate forms of data to users over the network. As usage of the internet has grown, so has the number of sites where files and other aggregate forms of data are stored. To facilitate users being able to review and retrieve information from the various sites on the internet, search engines have been developed. Some search engines are publicly available such as those implemented at www.yahoo.com, www.excite.com and www.altavista.com. Using the search engines at these sites, the user may type in terms related to topics of interest to a user. The search engine then identifies various sites where files or other data related to the topics of interest are stored. The user then uses information about the various sites displayed by the search engine to determine which ones the viewer wants to “visit” to evaluate the site.

While these publicly available search engines facilitate a user's identification of sites having information being sought by a user, they still require the user to conduct the search, review the results of the search and then conduct their own research on the various sites located by the search to locate information. In an effort to further facilitate a user's tasks to identify and retrieve data, agent programs have been developed that accept parameters identifying information of interest to a user. These agent programs then periodically conduct searches for data sites on the internet that have information related to the search parameters and collect relevant information from those identified sites. This information may then be downloaded to the user so the user may evaluate which information the user actually peruses.

These agent programs do alleviate some of the tasks associated with a user conducting their own research over the internet. However, the management of the agent program still must be performed by the user. In addition, agent programs do not parse the retrieved data files to eliminate redundant articles and images. Consequently, the user may have to sort through an unnecessary amount of data. Also, if any of the files downloaded included data objects that require interaction with a user, the user must go to the site on the internet and interact with that file and data object as the agent program is usually unable to do so.

What is needed is a system that does not need to be managed by a user but which provides information relevant to a user's needs on a periodic basis.

What is needed is a system that eliminates redundant files and images corresponding to identified parameters for data of interest to a user before delivering the data to the user for review.

What is needed is a system that permits a user to interact with data objects even though the data object is not being communicated during a session with a site from which the data object was retrieved.

### SUMMARY OF THE INVENTION

These and other limitations of previously known systems for retrieving data for users are overcome by a system and method of the present invention. The informational system of the present invention is comprised of a client component resident on a computer system at a user's computer and a server that collects electronic information corresponding to each user's customized profile for delivery to the client component. The information collected includes documents and images received from internet sites or it may include content from servers located at the server site facility. In one application of the present invention, the users are doctors and the content may include articles from medical publications addressing a doctor's practice specialty, information provided by sponsors for the informational system, and miscellaneous information of personal interest to a doctor. Documents and images from these various sources are retrieved and used to populate archives defined by a profile associated with an identified user for each client component in the system. Prior to delivering the contents collected for the archive, checksums identifying the articles and images within an archive are sent to the corresponding client component which verifies that an article or image has not been previously sent to the client. If the client sends a message to the server indicating that one or more articles or images have been previously transmitted to the client, those redundant elements are deleted from the archive. The remaining elements of the archive are then compressed in a streaming format and delivered to the client component. The downloaded archive is decompressed by the client component and provided to the user.

### BRIEF DESCRIPTION OF THE DRAWINGS

The accompanying drawings, which are incorporated and constitute a part of the specification, illustrate preferred and alternative embodiments of the present invention and, together with the general description given above and the detailed description of the embodiments given below, serve to explain the principle of the present invention.

FIG. 1 is a block diagram of a system architecture incorporating the inventive system and method of the present invention; and

FIG. 2 is a depiction of communications between a client and server implementing the system of the present invention.

### DETAILED DESCRIPTION OF THE INVENTION

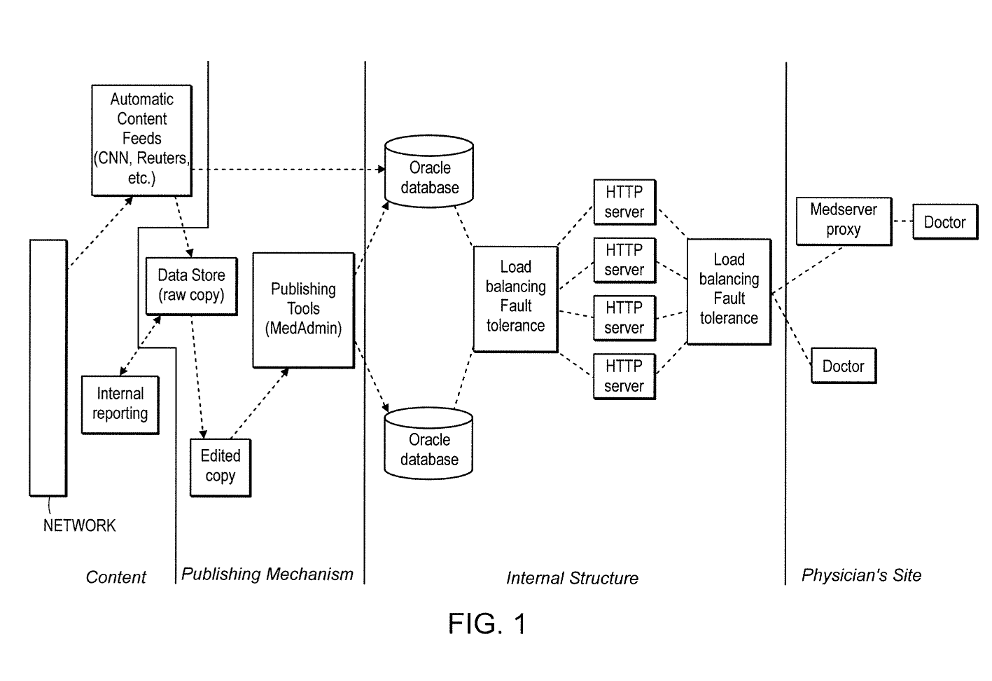

The informational system of the present invention utilizes the Internet pipeline to deliver news and information to a user's desktops. Start to finish, the informational publishing system can be briefly summed up in the four-part diagram shown in FIG. 1.

Content (Network—Automatic Content Feeds—Data Store—Internal Reporting)

Content consists of everything the physician receives from the system, including specialty specific medical news, policy news, continuing medical education (CME), reference resources, financial, travel and lifestyle information.

The Publishing Mechanism (Data Store—Edited copy—Publishing Tools)

The tools used to create, edit and ‘publish’ the content for a user. These include third-party applications for content creation, the Greenburg News Network (GNN) publishing tool Medcast Administrator, Continuing Medical Education test creation, and server side publishing.

Internal Network Architecture (Oracle Database—Load Balancing/Fault Tolerance—HTTP Server)

This includes the hardware and software GNN uses to process, store, and deliver content to the end users.

Physician's Site (Medserver Proxy-Server)

In a preferred embodiment, the users are physicians and the data content is targeted for physicians and their medical practices. The system discussed below is made with reference to this preferred embodiment. The terms ‘Medcast server’ and ‘Medcast client’ refer to the server and client components in this preferred embodiment. Details of the hardware and software used by the physicians and the manner in which they access Medcast content include a single-user set up with a modem; single user on a LAN with a wide area network; or multi-users on a Local Area Network (LAN) with a Medcast site server.

All Medcast client software is developed using Microsoft's visual C++, due to its wide acceptance, speed, and array of Software Development Kits (SDKs). Additionally, the ability to cross compile this software is important for compatibility with future upgrades and products.

All client software is 32-bit. This provides users of the inventive system with fast, flexible applications suitable for multi-tasking and multi-processing operating systems. The informational system of the present invention operates under Windows 95/98 and Windows NT operating systems, with twenty-four megabytes of RAM, though thirty-two is preferable.

Site Configurations

Single-User Set Up with Modem

A simple installation requiring software, hardware and configuration of an Internet Service Provider (ISP).

Single-User on a Local Area Network with a WAN

An installation of the software, configuration of ISP, and installation of hardware and Ethernet card for the LAN.

Large Multi-User Installations on a LAN with a Medcast Site Server

The proxy server of the present invention is Windows NT-based, which is designed to serve all Medcast subscribers on the LAN. Hardware for the proxy server consists of a 400 MHz Pentium with Ethernet, 64 Mb of RAM, tape backup, 4 Gb hard drive, 32x CD-ROM, 10/100 Ethernet Card, monitor, mouse and keyboard.

The proxy software server system acts as a proxy to the Medcast Broadcast Center. It enables each local user to receive updates from the local proxy server instead of the Medcast Broadcast server. This reduces the overall bandwidth requirements on the local LAN's Internet Connection and enables the local administrator to control the time of delivery and updates. It also provides the administrator controls for handling access to the proxy server.

Client Server Communications

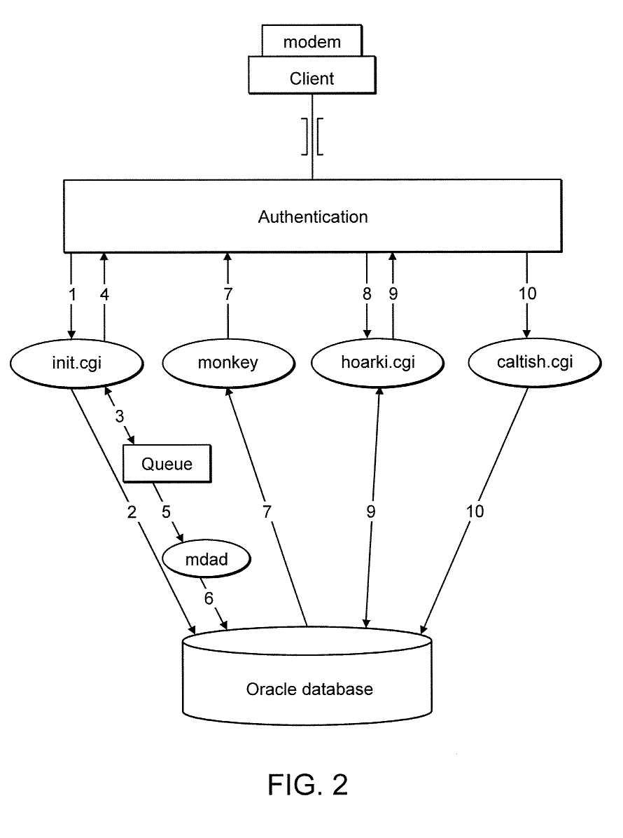

To deliver updates to a physician's site, the system of the present invention uses the TCP/IP standard protocol with a standard Internet connection. Configurable updating routines are available, allowing physicians to update their systems in the middle of the night if they use Microsoft's PPP dialer with Windows 95/98 or NT. If a physician is on a direct connection she or he can receive numerous updates throughout the day. The basic update process is described with reference to FIG. 2:

Authenticate

Authentication happens before every action.

User name and password given. Init.cgi sends information to the database and learns whether it's correct or not. (Or, to use an analogy, you've just walked in the door of a restaurant.)
1. Transmit log riles and content information (Analogy: you tell folks in the restaurant what you've been doing since last you saw them.)
2. Store log files and content information into the database (Analogy: your order number is generated.) Record session in queue (Analogy: your order number is given to you.)
3. Return session ID and server time (Analogy: You order “A number five, please.”) Get queue information and content list (Analogy: the chef receives your order.)
4. Get queue information and content list (Analogy: The chef receives your order.)
5. Generate file list and custom files (Analogy: Gathering the ingredients for what you ordered.)
6. Download list of files. This is a list of content identifiers the server thinks the client should have. (Analogy: on the server side this would consist of the entire recipe of what you just ordered. But what's sent to you, the client, is a stripped down version: instead of the ingredients of your order, you just see “A number five consists of cheese burger, rhubarb pie, milk”
7. Return optimized list. The client sends Hoark a list of files that the client doesn't require. (Analogy: You've learned exactly what a number five is and decide you don't want the milk because you brought one with you, so you return a list of what you don't want.)
8. Read files. Hoark reconstitutes what you've sent back, being sure you didn't reject something that wasn't on the list of offerings. (Analogy: the chef makes sure you didn't reject something that didn't come with your order.)
9. Download files. The files are downloaded. (Analogy: the dish is served.)
10. Acknowledgment. The client indicates all the files were received and whether or not there was a problem, this session is done. (Analogy: Bye, great pie, I'll be back!) A more detailed breakdown of the client server communications follows:
   Authenticate

Summary

Every interaction between the client and the services available at the server is mediated by a web server. This mechanism provides authentication, logging, and (potentially) load balancing using a single, popular, off the shelf tool. It also obviates any network code in the server side elements (the CGIs).

Every connection instance is authenticated using the standard “Basic Authentication” provided by the web server. Preferably, the authentication module which is integrated with an Apache web server and the module queries an Oracle database for authentication data. No data is transferred until authentication is successful.

Once past this initial step the client and the server side (CGI) process are connected. The CGI process has access to the client user name (via the remote_user environment variable) and a communications stream via Standard 10.

Details

The preferred authentication module used under Apache consults an Oracle database. It uses the popular “External Auth” module for Apache.

Configuring the web server to use this authentication method is done using SetExternalAuthMethod as:
SetExternalAuthMethod GNNAUTH function

Then for each table/column combination, an AddExternalAuth directive is added. The form of the directive is:

AddExternalAuth GNNAUTH GNNAUTH:table,user_col,passwd_col,style where table is the Oracle table name, user col is the column name of the username, and passwd_col is the column name of the password.

Style should be one of “clear” for plaintext passwords or “des” for unix style 13 character passwords.

If you use the special table name “oracle” then instead of checking an Oracle table, the given username and password is used to attempt to log into the Oracle database. If that works a “pass” is reported. (The other 3 arguments are ignored.)

Transmit Log Files And Content Information

Summary

This is the first step performed by init.cgi. The article request data is sent to the cgi by the client, the size of which is determined by an HTTP header. This data is put into the database LOB store. Next, the client activity log is sent to the server, the size of which is also in an HTTP header, and saved to a file on the server's file system. These log files are to be gathered and parsed by a separate process.

Details

User Activity Log

The Medcast client applications track the user's activity in a log file and transmit that log file to the Medcast server during each update. Once a log file has been transmitted, it is deleted from the client machine and a new log file is begun. The log file format is:

USERNAME\tUID\tMACHINEID\n

ACTION CATEGORY\tACTION\n

ACTION CATEGORY\tACTION_ID\n

The file consists of an initial line identifying the user and the machine being used. The following lines identify the sequence of actions the user performed since the previous update.

Action Categories

Action categories describe the general action that was performed. The categories consist of:

| | |
|---|---|
| AD | an ad played |
| ARC | saved an article to the archive |
| ART | an article was viewed |
| BTN | a button was pressed |
| CHN | the table of contents page for a channel was viewed |
| | via the channel selector or a channel:// command |
| ERR | an error occurred |

Action Identifiers

Action identifiers can have different meaning depending upon their associated action category.
AD the ID of the ad that was played; it is represented as <AID>.<GID>
ARC the ID of the article that was archived; it is represented as <AID>.<GID>
ART the ID of the article that was viewed; it is represented as <AID>.<GID> BTN the name of the button pressed; (if the button simply pulls up a TOC page, then the CHIN action is fired instead)
   EMAIL
   INTERNET
   OPEN
   FIND
   CUSTOMIZE
   DAILY (Daily Broadcast)
   EVENT (Live Events)
   SPONSOR (Sponsor Channels)
CHN the ID of the channel whose TOC page was viewed; it is represented as <GID>
ERR an error type identifier followed by an error message; valid error types are:
   Data an error in the databases; the accompanying error message will contain a number identifying the specific error
   otbx an error with the outbox; the accompanying error message contains some information about the offline form which failed to submit
Init.cgi returns a status 500 if it has an internal failure. All server errors are logged.
   Store Log Files And Content Information

Summary

This step happens pseudo-inline within init.cgi. The activity log data is streamed directly to a file as it is received. The article request information is stored in an intermediate buffer to be spooled to the server database. The LOB containing the article request contains ASCII data, as described above. This data is later interpreted by the MDAD process.

Details

See Appendix B, Step 4+ for examples of input, output and init's code.

Record Session In Queue

Summary

A new record is created in the download_queue table, populating the appropriate fields.

Details

The medcast_user_id, status, source_ip, queue_type fields are populated. The medcast_user_id is the user identification that the client uses to connect to the server, the status is set to the state of QUEUED as defined in download_queue states.h, the source_ip is passed from HTTP header information, and queuetype is set to ‘A’ or ‘M’ as gathered from the HTTP_UPDATE_TYPE environment variable. See Appendix B for examples of input, output and init's code.

Return Session ID And Server Time

Summary

The session_id assigned by the database to the newly inserted record in the download_queue table, is sent to the client along with the number of seconds elapsed on the server's clock since Jan. 1, 1970.

Details

These values are returned to the client as name=value pairs in the form of:

session_id=10859
time_t= 902361932

See Appendix B for examples of input, output and init's code.

Get Queue Information And Content List

This is a process request list which generates a list of articles and other lobs, plus a custom archive. For more details, see “Tradecast client to server request” in Appendix B-2 and all of Appendix D.

Generate File List And Custom Files

See Appendix D for mdad information.

Download List of Files

Summary

This step is performed by monkey.cgi. This list of files consists of a datum pair for each file, the pairs being an MD5 checksum of the file as stored in the server database, and the length of the file. This list of datum pairs is compared against files stored in the client database and duplicates are removed. (See Appendix A for examples of input, output and monkey's code.)

Details

The monkey CGI return data is composed of
Header: any lines beginning with # are part of the header and treated as comments. The header may or may not contain useful information but at the least it contains the version of the data format, and a current Unix-style date(3) string.
Data: provides a unique fingerprint for each file the server believes the client needs (the fingerprint consists of an MD5 checksum and a data length). The MD5 appears as a hexadecimal string 128 bits long, followed by a space, and then the long integral representation of the file's length as stored in the server database. The line is ended with the new line character'\n'.

#Version: 1.0

#Date: Jun. 22, 2001

| | |
|---|---|
| A fingerprint for every file that follows comes after the | monkey data |
| monkey - p header. The fingerprint is the ASCII | |
| representation of a 32 bit hex number representing | |
| the MD5 checksum, a space, then the size of the file | |
| is represented in bytes in ASCII digits. | |

Monkey.cgi returns an HTTP status of 509 if the server isn't ready for the client, and a status 510 if the client requests bogus article information, or MDAD is unable to process the request data.

Monkey.cgi returns a status 500 if it has an internal failure. All server errors are logged.

Return Optimized List, Read Files, and Download Files are Combined and Explained in the Following

Summary

Hoark is the service which sends content to the client system. In a previous step, the system has generated a download offerings list based on client input. This information (or a derivative) is available both to the client and the server.

Upon connection, the client transmits a selection of that list consisting of items which the client does not want downloaded (because it already has them locally). The server then transmits the remaining items from the original download offerings list.

Details

request phase: Client connects and sends a newline separated list of pointers into the offerings list (ASCII representation), followed by a blank line:

3\n

23\n

9\n

\n

response phase: Server sends a stream of commands to a virtual machine within the client. The generic command format is:

| | | |
|---|---|---|
| tag (1 byte) | length of data in bytes (32 bit | data (if any) |
| | unsigned integer) | |

All numeric data is transmitted in network byte order.

Tag definitions:

| Tag Symbol and transmitted | Data | |
|---|---|---|
| value | Length | Dates and Notes |
| END_CHANNEL(I) | | single channel ID (32 bit unsigned integer) All |
| | | content associated with this channel has now been |
| | | transmitted. |
| ENCODING (2) | 5 | encoding type (1 byte) |
| | | how many (32 bit unsigned integer) |
| | | The next how_Many bytes of the command stream |
| | | will be encoded according to encoding_type. It is |
| | | expected that zlib style compression will be the most |
| | | popular option. Only one ENCODING is allowed at |
| | | a time. |
| CONTENT (3) | ? | Data overwrites virtual machine content buffer |
| NO_CONTENT (4) | 0 | Effectively requests the client to load the virtual |
| | | machine content buffer using the content associated |
| | | with content_ID command. The client should be |
| | | able to do this because it was listed as an item the |
| | | client already has. |
| ARTICLE_INFO (5) | ? | Opaque article info, at least contains article and |
| | | channel id Write the content buffer as this article. |
| CONTENT_ID (6) | ? | MD5 sig and content length (ASCII representation), |
| | | separated by one space. |
| | | This command always immediately precedes the |
| | | content or no_content command which it's |
| | | associated with. |
| COMMENT (7) | ? | Comment text which may be logged by the client. |
| END_OF_TRANSMISSION | 1 | status (1 byte) |
| (9) | | All done, server drops the connection Nonzero status |
| | | indicates error condition. |
| START OF TRANSMISSION | 4 | server_version (32 bit unsigned integer) |
| (9) | | Must be first command sent to client. |
| SESSION_ITEMS (10) | 4 | The number of content and no-content tags to be |
| | | transmitted this session (a 32 bit unsigned integer). |
| | | This command is optional and may appear anywhere |
| | | in the session stream. |

Encoding and Compression:

The idea with the table above is that after an ENCODING command, the next n bytes of the data stream are decoded.

The client implementor writes a decoder atop whatever is reading the socket. This keeps track of the present encoding (if any) and returns uncompressed data to the client application.

Acknowledgment

See Appendix C for acknowledgment information.

### Appendix A

Appendix A: Monkey CGI

The Monkey CGI is the second step in the download process. It performs several actions both in the database, with input data, and returning data.

Monkey Process:
1. Retrieve HTTP_SESSION_ID from the environment.
2. Check to see if the user is active; disconnect if not.
3. SELECT the status field FROM download_queue WHERE session_id matches HTTP_SESSION_ID
4. If status (as defined in download_queue_states.h) is less than PROCESSED return: “Status: 509 Service not ready, try back later” “Retry-after: 30” and disconnect.
5. Else if status=BOGUS return: “Status: 510 Invalid article request data” and disconnect.
6. Else set status=MONKEYING and COMMIT database.
7. Search mdad_article listing for all records whose sessionid field matches HTTP_SESSION_ID.
8. Set crit field of each found record to the value of a sequentially updating counter, starting at 1.
9. Using the gnnlob_id field value in the found record, find the matching record in the gnnlob table, and save the length and md5 checksum fields.
10. Set status=MONKEYED in the download_queue record and COMMIT the database.
11. Return header and list of md5/lengths (a newline separates these blocks)

Monkey's Data:

monkey.cgi uses two database tables, download_queue and mdad_article_listing.

See comment in the CME section regarding these.

The Input:

HTTP Headers:

HTTP_SESSION_ID—The session_id that the client was given by init.cgi.

The Output:

The Header:

#Version: 1.0

#Date: Wed August 5 16:33:29 EDT 1998

The List:

54c3057549c969358fe33e41d8a2a7fb 1056

b43ca51181a2a97615a06a42a7c1170 3545

d382eca33fedbaOOcd24ff94f45bfa7a 1376

b4e23ef9158f56b410417c29a08d0c11 29172

77bb4d1578f8c64b1a6ab8c4678b8409 4376

The Code:

This CGI is composed of the following files:

monkey-cgi.cpp—Source file for CGI functions

monkey-db-funcs.pc—Source file for Oracle functions

monkey-cgi.cpp

This file contains the following functions:

take_a_pee—list the results for a user or all users

status_not_ready—return as status indicating that the client's download_queue record isn't ready.

status_queue_failure—return as status indicating that the client has requested bogus articles

take_a_pee
Declaration:
   short take_a_pee (const list<droplet> & droplets);
Arguments:
   droplets—a linked-list of droplet structs.
Returns:
   0 on success.
   −1 on failure.
   This function is very simple. It outputs a success status, a header, and then iterates over all items in droplets outputting each item's md5 checksum and length.

status_not_ready
Declaration:
   void status_not_ready
Arguments:
Returns:
   This function is called when it is determined that the server is not ready for the client to connect. It outputs an HTTP status 509 and disconnects.

status_queue_failure
Declaration:
   void status_queue_failure( )
Arguments:
Returns:
   This function is called when it is determined that the client has requested bogus article. It outputs an HTTP status 510 and disconnects.

monkey-db-funcs.pc

This file contains the following functions:

gather_droppings—retrieve article information from the database for the client

gather_droppings
Declaration:
   short gather_droppings(long session_id, list<droplet> &droplets)
Arguments:
   session_id—session_id given by the client.
   droplets—empty list of droplet structs.
Returns:
   0 on success.
   −1 on failure.
   This function is the checksum of the CGI. It performs all the checks described above, then queries the database for the md5 and length information that the client needs, and places them in a droplet struct, which is added to the droplets list.

### Appendix B

Appendix B: INIT CGI

The Init CGI is the first step in the download process. It performs several actions both in the database, with input data, and retuming data.
1. Read REMOTE_USER, HTTP_COMPRESSED, HTTP_LOG_LENGTH, HTTP_ARTICLE_LENGTH, and LOG_PATH from the environment.
2. Check the database for the state of the user. If they're inactive, drop the connection.
3. Construct path to file to contain activity log data. This is in the form of: LOG PATH[/]REMOTE_USER-<time>.log [.gz] where <time> is in the form of 21:34:28, and.gz is appended if HTTP_COMPRESSED is set to
4. Open the log output file.
5. Read in HTTP_ARTICLE_LENGTH bytes of data to a buffer, to be stored in the database.
6. Read in HTTP_LOG_LENGTH bytes of data to the log file opened above.
7. Close the.log file
8. Read REMOTE_ADDR, REMOTE_USER, and HTTP_UPDATE_TYPE from the environment.
9. INSERT INTO download_queue user_id, source_ip, update_type as REMOTE_USER, REMOTE_ADDR, HTTP_UPDATE_TYPE, retrieving the session_id of the new record, which is inserted automatically by a database trigger.
10. INSERT the article request_data buffer into the LOB store using the request data column to save the gnnlob_id of the stored data.
11. COMMIT the database.
12. If successful, return the session_id and the value of time(NULL) to the client.
   The Input:
   HTTP Headers:
   Set by the HTTP server for all cgi's:

remote_user—The id of the authenticated client user.

remote_addr—The IP address of the client machine.

Set by the HTTP server especially for init.cgi:

LOGPATH—Path to use for the saved activity log file.

Set by the client when connecting:

HTTP_COMPRESSED—Indicates if the activity log data is zlib compressed.
HTTP_LOG_LENGTH—Length in bytes of the activity logo data.
HTTP_ARTICLE_LENGTH—Length in bytes of the article request data.
HTTP_UPDATE_TYPE—Values of ‘A’ or ‘M’ indicate automatic or manual download, respectively.
I=inhouse; to staged content is downloaded. T=testing; mdad is being tested.
   Tradecast client to server reauest/Article Reauest Data:
   Summary

ARTICLES:71; 1+

ARTICLES:69; 1+

ADS IN:75;

ADSIN:51

ARTICLES:81; 1+

Details

Article Group Download Request

ARTICLELIST_STR “:” <gid> “;” <article limit> <article group list>
NL

| | |
|---|---|
| <gid> | = group id |
| <article limit> | = ““ I” <“<number>”,” |

(signifies that no more than ‘number’ articles should be downloaded)

| | |
|---|---|
| <article group list> | = <article> “-” <article> |
| <article group list> | = <article> |
| <article group list> | = <article group list> “,” <article> |
| <article group list> | = <article> “+” |

where the plus ‘+’ signifies all articles <= listed article

| | |
|---|---|
| <article group list> | = <article group list> “,” <article< “-” <article> |

where the dash ‘-’ signifies a range of articles
NL = “\n”
ARTICLELIST_STR= “ARTICLES”
(if no articles exist, request should be 1+)
--- “article limit” is being disabled as a feature

Ads Download Request

ADSLIST_STR“:” <gid> “;” <ad-list<
<ad> = download id of ad
<ad_list> = “”
<ad_fist> = <ad>
<ad_list> = <ad>, <ad-list>
ADSLIST_STR = “ADS_IN”
where ad_list is all the ads for the given group.

Stocks Download Request

STOCK LIST STR“:”<5-ietter-code-list>NL

| | |
|---|---|
| <5-letter-code-list> | = 5-letter-code- list>“,” <5-letter-code< |

<5-letter-code> = code assigned by stock exchange (nyse, nysdex, etc)
---‘JANSX’, etc (at most MAX_STOCKS per line)
STOCK_LIST_STR “STOCK”
NL = “\n”

| | |
|---|---|
| MAX_STOCK | = 25 |

Activity Log Data:

BTN CUSTOMIZE

BTN FIND

BTN CUSTOMIZE

BTN CUSTOMIZE

BTN FIND

BTN CUSTOMIZE—Kevin

CHN 56

CHN 0

ART 1.1

CHN 7-09520

ART 1.1

CHN 0

ART 1.1

CHN 5118196

ART 1.1

The Output:

The output consists of very simple name/value pairs.
session_id=1034587
time_t=902361932
session_id is the value that the client should return when connecting to monkey.cgi, hoark.cgi, et. al. time_t is the value returned by calling time(NULL). It is used to determine what time the server thinks it is, so that the client and the server can be in sync.

The Code:

This CGI is composed of the following files:
Initcgi.cpp—Source file for CGI functions
init_db funcs.pc—Source file for Oracle functions

init-cgi.cpp

This file contains the following functions:

read_log_file—read the log file and request data in from the stream
print_output—return data to the client

read_log_file
Declaration:
   short read_log_file(string &request data)
Arguments:
   request_data—string to be populated with the article request data from the client.
Returns:
   0 on success
   −1 on failure
   This function is designed to read in a specific number of bytes of article request data and a specific number of bytes of activity log data as described above.
      print_output
Declaration:
   short print_output (long session id)
Arguments:
   session_id—session_id given by the client.
Returns:
   0 on success.
   −1 on failure.
   This function returns to the client the session_id and time_t identifiers as described above.

init-db-funcs.pc

This file contains the following functions:

add_dlq_record—insert a new record into the download queue table

display_options
Declaration:
   short add_dlq_record (long & session_id, const string & request_data);
Arguments:
   session_id-session_id given by the client.
   request_data—contains the request date from the client.
Returns:
   0 on success.
   −1 on failure.
This function inserts a new record in to the download_queue table and adds the article request data from the client to the LOB store as described above.

### Appendix C

Appendix C: Catfish CGI

Catfish is the last cgi called by the client and its purpose is to clean up download_queue and mdad_article_listing, custom info and request data.

When:
Download-queue status is:
HOARKED or
DELETING or
BOGUS
session_id exist in download_queue user_id is user_id for given session

Protocol:
client sends session_id as an HTTP header (SESSION_ID: session_id)
such that Apache sets the environment variable
HTTP_SESSION_ID. gets the user_id from the appache auth.

Success:
200 status
LAST_UPDATE: TIME TO BE RETURNED TO INIT ON NEXT UPDATE
DAILY_UPDATES: list of times for client to do its next updates

Errors:
503 unable to connect to database
507 unable to cleanup download queue
400 improper input
/opt/gnn/bin/catfish.cgi.cron_cleanup calls
opt/gnn/download_htdocs/catfishlcatfish.cgi.cron cleanup
/opt/gnn/download_htdocs/catfish/catfish.cgi.cron_cleanup
sets env

Cron cleanup:
CATFISH_CLEANUP_TIMEOUT number of seconds since last mod to denote expired download queue item
CATFISH_EXTRA_WHERE extra where clause for cleanup
CATFISH_ALL just needs to be set
HTTP_SESSION_ID CLEANUP_ALL
GNN_DBUSER oracle user
GNN_DBPASSWD password for the oracle user
   Basically calls catfish.cgi with CATFISH_ALL set and HTTP_SESSION_ID set to “CLEANUP ALL” and catfish will go through the download queue and get any items that have not been modified in the last X seconds where X is
   CATFISH_CLEANUP_TIMEOUT if set to the default (currently 1 day). Overrides catfish constraint that the queue time have one of the approved statuses.

### Appendix D

Appendix D: Catfish CGI

Source files uniquely for mdad
   make_download_archive.c
   mdad_tmp_table.pc
   make_archives.c
source files uniquely for mdad.runnerd
   mdad.runner.c
      Environment variables used by mdad and mdad.runnerd
mdad path
   path to mdad for mdad.runnerd to run may be full or relative
   mdad.runnerd does not chdir.
email_error_to
   address to send email errors to default
   “<tradecast.server.error@GNNcast.net>”
gnn_dbname
   oracle sid
medcast_download_spool
   spool directory for custom data
debug_tmp_dir
   where to put tmp files

LOG FILES

mdad.runnerd
$TC_LOG_DIR/make_archive. log—runtime log
debug logs—latest.log is the latest log
$DEBUG_TMP_DIR/debug/download/mdad.runnerd.dir/*

mdad
$TC_LOG_DIR/mdad.log—runtime log
debug logs—latestlog is the latest log
$DEBUG_TMP_DIR/debug/download/INSTANCE/mdad.dir/*
$DEBUG_TMP_DIR/debug/download/mdad.dir/*
debugging log files may be eliminated by not compiling with HDEBUG defined

USAGE: mdad.runnerd.csh [NUMBER]

USAGE: mdad.runnnerd [NUMBER]
NUMBER is the number of mdads to keep going. Default is one max, and is currently 64. It is set by the number of members of the array mdad

kids in mdad.mmner.c

mdad.runnerd.csh
is a shell script which sets some env variables and runs itself in the backgroup and keeps mdad.runnerd going. If mdad runnerd exits with an exit status of 0, mdad.runnerd.csh also exits with an error status of 0.

mdad.runnerd
is a compiled executable which keeps X mdads running where X is the first arg on the command line.
   1<=X<=max mdad kids (currently 64)

Email of Errors

Every time a kid stops (dies/quits) mdad.runnerd restarts the kid, logs it, and sends email to mdad_gnncast.net if it has not sent email within the last X seconds (currently 300).

If mdad.runnerd restarts X kids within Y seconds, and it's been more than Z seconds since it last sent email to alert, mdad.has problems @ GNNcast.net, it does so.
Y is currently 15 minutes (15*60)
Z is currently 20 minutes (20*60)
X is currently 128 defined by the number of members of kwpq

Signals
hup—kills off all kids and executes itself
term—kills off all kids and quits
int—ditto
quit—ignored

Note
opens the runtime logfile with an exclusive to write so only one mdad.runnerd may run at a time.

Bugs
does not kill off mdads still running when it starts

USAGE: mdad [LOGFILE ID] [SLEEP SECONDS]

logfile_fd
negative pid of parent do not try to open
−1 attempt to open runtime log file of mdad.runnerd exclusively for writing.

sleep seconds
number of seconds to do nothing between no items found in the queue.
   Plan of attack

startup cleanup
Looks for mdad_tmp_tables for the current host (application server) which needs to be cleaned up (dropped). Resets any download_queue time back to QUEUED (20) that are at PROCESSING (30) if the mdad_tmp_table which created them does not exist.
   Main Processing Loop Steps
1. Finds first queue request in download_queue, first request is first one by queue_type then by create time where queue type is sorted by:
   a. tc_dlgt_manual (‘M’)
   b. tc_dlgt in_house (‘H’)
   c. tc_dlgt_automatic (‘A’)
   d. tc_dlgt_testing (T)
2. Sets that status to PROCESSING (30) and fills in the mdad_tmp_jable in the download_queue
3. Calls process_article_requests to obtain the request data in a parsed format file. Currently this functionality is in imglue.so
4. Sets up temp param files. This is some of the custom info, mostly about the articles/channels of which the client needs to know. See OW mdad processes request data for more info
5. Processes request filling up mdad_article_listing and adding to param files and inserting custom info into the tear archive (custom archive).
6. Put the param files as the last items in the tear archive.
7. Set the status of the download_queue item to be processed.
8. 7 goto 1.
   How nidad processes request data
1. Creates one or more SQL queries from the request list which adds the article global ids to the tmp table, and executes them. After the initial insertion of articles into the tmp table, a query is performed to add all the offspring (children, grandchildren, etc) of all articles which are in the tmp table. Currently this is done in such a way that the article is only in the tmp table once. It may be more efficient to have this uniqueness performed in step 2.
2. Takes all the lists of article global ids in the tmp table and adds them to the mdad_article_listing table, leaving only tcar_name and cnt+++ to be filled in later.
3. Runs through the mdad_article_listing table for this session, adding appropriate info to the param files for each article, and filling in the tcar_name column of the table.
4. By looking at the last_update time, and decrementing it by a fixed amount, adds state info to the param files about deleted articles, channel mods.
5. Examines the clients overall version and adds the appropriate items to the download list along with a script to tell the client what to do with the new version update files.
   +++the cnt column is filled in by monkey after determining what order to send down the fingerprints (md5 cksum and len).

1-6. (canceled)

7. A method for providing a user with a customized data based on a user profile, the method comprising the steps of:
collecting electronic data based on the user profile;
storing the collected data in a database;
sending to the user a checksum of the collected data;
receiving from the user an indication of data previously sent to the user based on the checksum; and
sending to the user the electronic data that has not been previously sent to the user.

8. The method of claim 7 further comprising a step of deleting from the database electronic data that has been previously sent to the user.

9. The method of claim 7, wherein the step of sending electronic data comprises a step of compressing electronic data into a streaming data format.

10. The method of claim 7, where in the user profile identifies the type of data to be collected and stored in the database.

11. The method of claim 7, wherein the electronic data is collected on the Internet.

12. The method of claim 7, wherein the collected data comprises one or more of articles, images, and multimedia files.

13. The method of claim 7, wherein the collected data is a healthcare related data.

14. A system for providing a user with a customized data based on a user profile:
a server component operable to collect electronic data based on the user profile and to generate a checksum of the collected data to be send to the user;
a database coupled to the server component for storing the collected data; and
a client component residing on a computer of the user and operable to receive a checksum of the collected data from the server, to determine from the received checksum data previously sent to the user, and to send to the server component an indication of data previously sent to the user.

15. The system of claim 14, wherein the server component is further operable to delete from the database electronic data previously sent to the user.

16. The system of claim 14, where in the server component is further operable to compress electronic data to be send to the user into a streaming data format.

17. The system of claim 14, wherein the user profile identifies the type of data to be collected by the server component and stored in the database.

18. The system of claim 14, wherein the electronic data is collected on the Internet.

19. The system of claim 14, wherein the collected data comprises one or more of articles, images, and multimedia files.

20. The system of claim 14, wherein the collected data is a healthcare related data.

21. A method for customizing electronic data based on a user profile, the method comprising the steps of:
receiving from a server a checksum of electronic data collected by the server based on the user profile;
identifying from the received checksum data previously sent by the server;
sending to the server an indication of data previously sent by the server based on the checksum; and
receiving from the server electronic data that has not been previously sent by the server.

22. The method of claim 21, wherein the electronic data comprises one or more of articles, images, and multimedia files.

23. The method of claim 21, wherein the electronic data is a healthcare related data.

24. The method of claim 21, wherein the step of receiving electronic data from the server comprising receiving electronic data in a streaming data format.

25. The method of claim 7, wherein the sent checksum identifies one or more collected data items.

26. The system of claim 14, wherein the generated checksum of the collected data identifies one or more collected data items.

27. The method of claim 21, wherein the checksum received from the server identifies one or more data items.
